(19) United States
(12) Patent Application Publication
(10) Pub. No.: US 2013/0063411 A1
(43) Pub. Date: Mar. 14, 2013

(54) IPS PIXEL UNIT, LIQUID CRYSTAL DISPLAY AND IMAGE CONTROL METHOD

(71) Applicants: Hung-lung Hou, Shenzhen (CN); Chengming He, Shenzhen (CN)

(72) Inventors: Hung-lung Hou, Shenzhen (CN); Chengming He, Shenzhen (CN)

(73) Assignee: Shenzhen China Star Optoelectronics Technology Co., Ltd., Shenzhen (CN)

(21) Appl. No.: 13/380,890

(22) PCT Filed: Sep. 23, 2011
(86) PCT No.: PCT/CN11/80075

§ 371 Date: Dec. 26, 2011

(30) Foreign Application Priority Data
Sep. 14, 2011 (CN) 201110269883.2

(51) Int. Cl. G09G 3/36; G09G 5/00; G09G 3/20

(52) U.S. Cl. 345/212; 345/55; 345/92

(57) ABSTRACT

An in-plane switch (IPS) pixel unit comprises: a plurality of pixel electrodes, signal lines, voltage switch modules and control switches. The pixel electrodes are divided into at least two pixel electrode regions respectively connected to the signal lines via one voltage switch module; the control switches controls connection with the voltage switch modules respectively; and the signal lines supply voltage signals to the pixel electrodes through the control of the control switches over the voltage switch modules. With the IPS pixel unit, when the display switches from a three-dimensional (3D) displaying mode to a two-dimensional (2D) displaying mode, the aperture ratio of the display remains unchanged, and the display will have a high brightness level and low power consumption; and a situation where the number of available pixels in is decreased to cause a lower resolution and more significant black lines is avoided, the resolution of the display is increased.

### BACKGROUND

1. Technical Field

The present disclosure relates to the technical field of liquid crystal displays (LCDs), and more particularly, to an in-plane switch (IPS) pixel unit, an LCD comprising the same and an image control method.

2. Description of Related Art

In in-plane switch displays of the prior art, pixels are not divided into different regions. In order to avoid the cross-talk occurring at large viewing angles when a polarizing 3D IPS display is used, a wide black matrix (BM) photomask must be made in the pixels of the IPS display to mask pixel electrodes in a portion of pixel regions so as to block the light traveling to pixel electrodes located at large viewing angles or to turn off pixel electrodes of a whole region. In this way, a 3D effect can be achieved.

However, when the practice of making a wide BM photomask to block light traveling to pixel electrodes located at large viewing angles is adopted, the BM photomask of the prior art masks the pixel regions at all times. On the other hand, in the 2D displaying mode, it is necessary for pixel electrodes in more pixel regions to become bright in order to increase the number of bright regions and to enhance the brightness. Consequently, when the IPS display switches from the 3D displaying mode to the 2D displaying mode, the BM photomask that masks a portion of the pixel regions at all times will cause pixel electrodes in the portion of pixel regions to become dark, which results in a decreased aperture ratio (i.e., the size of the bright region), a low brightness level and higher power consumption. Consequently, the number of available pixels in the whole display is decreased to cause a lower resolution and more significant black lines.

### BRIEF SUMMARY OF THE DISCLOSURE

The primary objective of the present disclosure is to provide an IPS pixel unit and an LCD comprising the same which can avoid degradation in the aperture ratio and the resolution when the display switches from a 3D displaying mode to a 2D displaying mode.

Technical solutions adopted in the present disclosure to solve the technical problems are as follows.

The present disclosure provides an in-plane switch (IPS) pixel unit, which comprises:

a plurality of pixel electrodes, signal lines, voltage switch modules and control switches, wherein the plurality of pixel electrodes are divided into at least two pixel electrode regions, each of which is connected to one of the signal lines via one of the voltage switch modules; the control switches are adapted to control connection with the voltage switch modules respectively; and the signal lines are adapted to supply voltage signals to the pixel electrodes of the pixel electrode regions through the control of the control switches over the voltage switch modules.

Preferably, each of the voltage switch modules is a semiconductor layer of a thin film transistor (TFT).

Preferably, the signal lines are connected to the voltage switch modules so that voltage signals on the signal lines are transferred to the pixel electrodes via the voltage switch modules controlled by a same control switch, or the signal lines are connected to the voltage switch modules so that the voltage signals on the signal lines are transferred to the pixel electrodes via the voltage switch modules that are each controlled by a respective control switch.

Preferably, each of the control switches is a gate line of the TFT.

The present disclosure provides a liquid crystal display (LCD), which comprises an IPS pixel unit. The IPS pixel unit comprises:

a plurality of pixel electrodes, signal lines, voltage switch modules and control switches, wherein the plurality of pixel electrodes are divided into at least two pixel electrode regions, each of which is connected to one of the signal lines via one of the voltage switch modules; the control switches are adapted to control connection with the voltage switch modules respectively; and the signal lines are adapted to supply voltage signals to the pixel electrodes of the pixel electrode regions through the control of the control switches over the voltage switch modules.

Preferably, each of the voltage switch modules is a semiconductor layer of a TFT.

Preferably, the signal lines are connected to the voltage switch modules so that voltage signals on the signal lines are transferred to the pixel electrodes via the voltage switch modules controlled by a same control switch, or the signal lines are connected to the voltage switch modules so that the voltage signals on the signal lines are transferred to the pixel electrodes via the voltage switch modules that are each controlled by a respective control switch.

Preferably, each of the control switches is a gate line of the TFT.

The present disclosure further provides an image control method for an LCD, which comprises the following steps of:

disposing at least two pixel electrode regions in an IPS pixel unit, disposing a voltage switch module connected with pixel electrodes and a control switch connected with the voltage switch module in each of the pixel electrode regions, and connecting a signal line to the voltage switch module so that a voltage signal on the signal line is transferred to the pixel electrodes via the voltage switch module controlled by the control switch; and

when the LCD switches from a three-dimensional (3D) displaying mode to a two-dimensional (2D) displaying mode, using the control switch to control the voltage switch module so that the signal line is enabled to transfer the voltage signal to the corresponding pixel electrode region.

Preferably, this method further comprises:

when the LCD switches from the 2D displaying mode to the 3D displaying mode, one of the control switches of the IPS pixel unit controls the voltage switch module of a corresponding one of the pixel electrode regions to disable the voltage signal inputted from the signal line into the pixel electrode region so that this pixel electrode region becomes a dark region, and meanwhile, the other control switches control the voltage switch modules of the other pixel electrode regions to enable voltage signals inputted by corresponding signal lines into the pixel electrode regions so that the other pixel electrode regions become bright regions.

Preferably, the signal lines are connected to the voltage switch modules so that voltage signals on the signal lines are transferred to the pixel electrodes via the voltage switch modules controlled by a same control switch, or the signal lines are connected to the voltage switch modules so that the voltage signals on the signal lines are transferred to the pixel electrodes via the voltage switch modules that are each controlled by a respective control switch.

Preferably, each of the voltage switch modules is a semiconductor layer of a TFT.

Preferably, each of the control switches is a gate line of the TFT.

The technical solutions of the present disclosure have the following benefits: in the IPS pixel unit and the LCD comprising the same according to the present disclosure, a plurality of electrodes of one pixel unit are divided into at least two regions independent of each other so that the bright/dark status of the pixel electrodes of the at least two regions can be controlled respectively; and then, when the display switches from a 3D displaying mode to a 2D displaying mode, all the pixel electrodes are controlled to become bright without causing degradation in the aperture ratio of the display. As a result, the display will have a high brightness level and low power consumption in the 2D displaying mode; and because the problem that, due to masking of pixels of a whole pixel region, the number of available pixels in the whole display is decreased to cause a lower resolution and more significant black lines is avoided, the resolution of the display is increased.

### BRIEF DESCRIPTION OF THE DRAWINGS

FIG. 1 is a schematic structural view of a first embodiment of an IPS pixel unit according to the present disclosure;

FIG. 2 is a schematic structural view of a second embodiment of the IPS pixel unit according to the present disclosure; and

FIG. 3 is a flowchart diagram of an image control method for an LCD according to the present disclosure.

Hereinafter, implementations, functional features and advantages of the present disclosure will be further described with reference to embodiments thereof and the attached drawings.

### DETAILED DESCRIPTION

For better understanding of the objectives, technical solutions and advantages of the present disclosure, the present disclosure will be further detailed with reference to embodiments thereof and the attached drawings. It shall be understood that, the embodiments described herein are only intended to illustrate but not to limit the present disclosure.

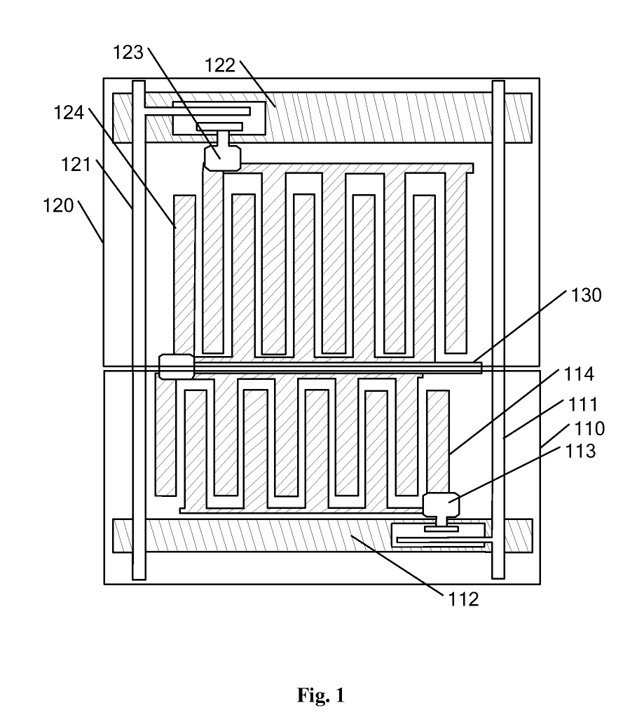

Referring to FIG. 1, there is shown a schematic structural view of a first embodiment of an in-plane switch (IPS) pixel unit according to the present disclosure. The IPS pixel unit is divided into a first pixel electrode region 110 and a second pixel electrode region 120. The first pixel electrode region 110 comprises first pixel electrodes 114, a first signal line 111, a first voltage switch module 113 and a first control switch 112. The second pixel electrode region 120 comprises second pixel electrodes 124, a second signal line 121, a second voltage switch module 123 and a second control switch 122. A grounding terminal 130 is disposed between the first pixel electrode region 110 and the second pixel electrode region 120, and is connected to the first pixel electrodes 114 and the second pixel electrodes 124 respectively. The first signal line 111 is connected to the first voltage switch module 113 via the first control switch 112. The second signal line 121 is connected to the second voltage switch module 123 via the second control switch 122.

In this embodiment, this pixel unit may be divided into more pixel electrode regions independent of each other; and each of the pixel electrode regions is provided with a signal line, a voltage switch module and a control switch separately with no signal or electric connection existing between the different pixel electrode regions. The signal line is adapted to supply a voltage signal to the pixel electrodes of the pixel electrode region so that the pixel electrodes become bright. Under the control of the control switch, the voltage switch module enables or disables the signal line to supply a voltage signal to the pixel electrodes of the pixel electrode region. The bright/dark statuses of the pixel electrode regions are controlled independently of each other. Thereby, when the display switches from a three-dimensional (3D) displaying mode to a two-dimensional (2D) displaying mode, the pixel electrodes can be flexibly controlled to become dark or bright. Specifically, in the 2D displaying mode, all the pixel electrodes are controlled to become bright to avoid degradation in the aperture ratio (i.e., the size of the bright regions) of the display, increase the brightness level and reduce the power consumption; and because all the pixel electrode regions become bright, the problem that the number of available pixels in the whole display is decreased to cause a lower resolution and more significant black lines is avoided. When the display switches from the 2D displaying mode to the 3D displaying mode, the pixel electrodes of one of the pixel electrode regions of the pixel unit can be disabled so that the pixel electrode region becomes a dark region. The pixel electrode region that becomes the dark region can block the light generated by the pixel electrodes in the bright pixel electrode regions at both sides thereof from leaking into an inappropriate phase retardation film, thereby achieving a better 3D effect of a polarizing 3D display.

In the aforesaid embodiment, the first voltage switch module 113 and the second voltage switch module 123 are each preferably a semiconductor layer of a thin film transistor (TFT); and the first control switch 112 and the second control switch 122 are each preferably a gate line of the TFT. Two ends of the semiconductor layer are connected to the corresponding signal line and the corresponding pixel electrodes respectively. When the gate line outputs a high-voltage signal, the semiconductor layer is turned on and the signal from the signal line is transmitted to the pixel electrodes of the corresponding pixel electrode region via the semiconductor layer; and when the gate line is at a low voltage, the semiconductor layer is turned off. In other embodiments, the first control switch 112 and the second control switch 122 may also be other modules that can control turning-on or -off of the voltage switch modules. In addition, in order to provide a voltage difference across the pixel electrodes, the pixel electrodes of each of the pixel electrode regions are connected to the grounding terminal 130.

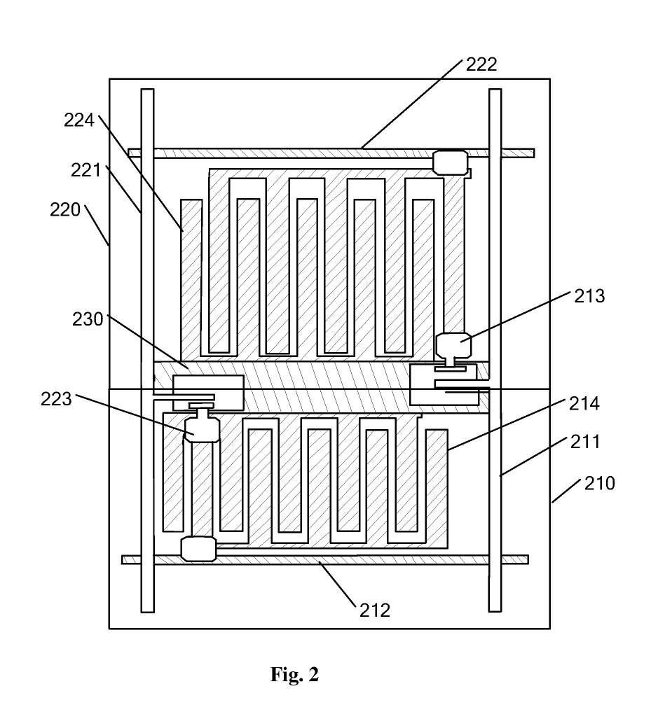

Referring to FIG. 2, there is shown a schematic structural view of a second embodiment of the IPS pixel unit according to the present disclosure. The IPS pixel unit is divided into a first pixel electrode region 210 and a second pixel electrode region 220. The first pixel electrode region 210 comprises first pixel electrodes 214, a first signal line 211, a first voltage switch module 223 and a first grounding terminal 212. The second pixel electrode region 220 comprises second pixel electrodes 224, a second signal line 221, a second voltage switch module 213 and a second grounding terminal 222. The IPS pixel unit of the second embodiment differs from the IPS pixel unit of the first embodiment in that: the IPS pixel unit of the second embodiment has only one control switch 230, via which the first signal line 211 is connected to the first voltage switch module 223 of the first pixel electrode region 210 and the second signal line 221 is connected to the second voltage switch module 213 of the second pixel electrode region 220.

In this embodiment, preferably, the first voltage switch module 223 and the second voltage switch module 213 are each a semiconductor layer of a TFT; and the control switch 230 is a gate line of the TFT. In other embodiments, the control switch 230 may also be other modules that can control turning-on or -off of the voltage switch modules.

An embodiment of the present disclosure further provides a liquid crystal display (LCD), which comprises an IPS pixel unit. The IPS pixel unit comprises: a plurality of pixel electrodes, signal lines, voltage switch modules and one or more control switches. The plurality of pixel electrodes are divided into at least two pixel electrode regions, each of which corresponds to one of the signal lines and one of the voltage switch modules; and all the signal lines are connected to the voltage switch modules via the same control switch or different control switches.

In this embodiment of the LCD according to the present disclosure, the IPS pixel unit comprises all the technical solutions in the first embodiment and the second embodiment, which have already been described above with reference to FIG. 1 and FIG. 2 and thus will not be further described herein.

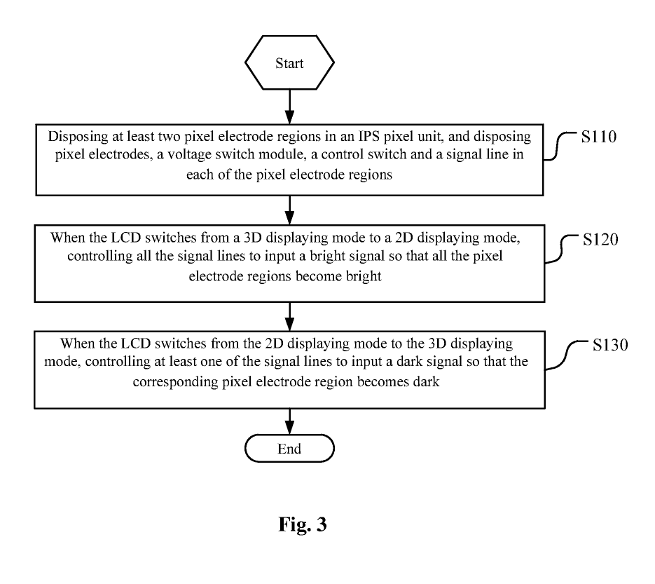

Referring to FIG. 3, there is shown a flowchart diagram of an image control method for an LCD according to an embodiment of the present disclosure. The image control method for the LCD comprises the following steps of:

S110: disposing at least two pixel electrode regions in an IPS pixel unit, disposing a voltage switch module connected with pixel electrodes and a control switch connected with the voltage switch module in each of the pixel electrode regions, and connecting a signal line to the voltage switch module so that a voltage signal on the signal line is transferred to the pixel electrodes via the voltage switch module controlled by the control switch; and

S120: when the LCD switches from a 3D displaying mode to a 2D displaying mode, using the control switch to control the voltage switch module so that all the signal lines are enabled to transfer the voltage signals to the corresponding pixel electrode regions.

Additionally, in other embodiments, the image control method for the LCD may further comprise:

S130: when the LCD switches from the 2D displaying mode to the 3D displaying mode, one of the control switch controls the voltage switch module of a corresponding one of the pixel electrode regions to disable the voltage signal inputted from the signal line into the pixel electrode region so that this pixel electrode region becomes a dark region, and meanwhile, the other control switches control the voltage switch modules of the other pixel electrode regions to enable voltage signals inputted by corresponding signal lines into the pixel electrode regions so that the other pixel electrode regions become bright regions. In this way, the pixel electrode region that becomes the dark region can block the light generated in the bright pixel electrode regions at both sides thereof from leaking so as to improve the 3D display without degrading the resolution and to avoid the cross-talk occurring at large viewing angles in the 3D displaying mode. In this embodiment, the voltage switch module of each pixel electrode region may correspond to one control switch respectively; and alternatively, the voltage switch modules of all the pixel electrode regions may also correspond to the same control switch.

By means of this method, all the pixel electrode regions of the LCD in the 2D displaying mode can be controlled to become bright without causing degradation in the aperture ratio (i.e., the size of the bright regions) of the display in the 2D displaying mode. As a result, the display will have a high brightness level and low power consumption in the 2D displaying mode; and because the problem that, due to masking of pixels of a whole pixel electrode region, the number of available pixels in the whole display is decreased to cause a lower resolution and more significant black lines is avoided, the resolution of the LCD in the 2D displaying mode is increased.

In the aforesaid embodiment, “the signal lines are connected to the voltage switch modules via the control switches” comprises: all the signal lines are connected to the voltage switch modules via the same control switch.

Preferably in the aforesaid embodiment, each of the voltage switch modules is a semiconductor layer of a TFT.

Preferably in the aforesaid embodiment, each of the control switches is a gate line of the TFT.

What described above are only preferred embodiments of the present disclosure but are not intended to limit the scope of the present disclosure. Accordingly, any equivalent structural or process flow modifications that are made on basis of the specification and the attached drawings or any direct or indirect applications in other technical fields shall also fall within the scope of the present disclosure.

1. An in-plane switch (IPS) pixel unit, comprising:
a plurality of pixel electrodes, signal lines, voltage switch modules and control switches, wherein the plurality of pixel electrodes are divided into at least two pixel electrode regions, each of which is connected to one of the signal lines via one of the voltage switch modules; the control switches are adapted to control connection with the voltage switch modules respectively; and the signal lines are adapted to supply voltage signals to the pixel electrodes of the pixel electrode regions through the control of the control switches over the voltage switch modules.

2. The IPS pixel unit of claim 1, wherein each of the voltage switch modules is a semiconductor layer of a thin film transistor (TFT).

3. The IPS pixel unit of claim 2, wherein the signal lines are connected to the voltage switch modules so that voltage signals on the signal lines are transferred to the pixel electrodes via the voltage switch modules controlled by a same control switch, or the signal lines are connected to the voltage switch modules so that the voltage signals on the signal lines are transferred to the pixel electrodes via the voltage switch modules that are each controlled by a respective control switch.

4. The IPS pixel unit of claim 2, wherein each of the control switches is a gate line of the TFT.

5. A liquid crystal display (LCD), comprising an IPS pixel unit, the IPS pixel unit comprising:
a plurality of pixel electrodes, signal lines, voltage switch modules and control switches, wherein the plurality of pixel electrodes are divided into at least two pixel electrode regions, each of which is connected to one of the signal lines via one of the voltage switch modules; the control switches are adapted to control connection with the voltage switch modules respectively; and the signal lines are adapted to supply voltage signals to the pixel electrodes of the pixel electrode regions through the control of the control switches over the voltage switch modules.

6. The LCD of claim 5, wherein each of the voltage switch modules is a semiconductor layer of a TFT.

7. The LCD of claim 6, wherein the signal lines are connected to the voltage switch modules so that voltage signals on the signal lines are transferred to the pixel electrodes via the voltage switch modules controlled by a same control switch, or the signal lines are connected to the voltage switch modules so that the voltage signals on the signal lines are transferred to the pixel electrodes via the voltage switch modules that are each controlled by a respective control switch.

8. The LCD of claim 6, wherein each of the control switches is a gate line of the TFT.

9. An image control method for an LCD, comprising the following steps of:
disposing at least two pixel electrode regions in an IPS pixel unit, disposing a voltage switch module connected with pixel electrodes and a control switch connected with the voltage switch module in each of the pixel electrode regions, and connecting a signal line to the voltage switch module so that a voltage signal on the signal line is transferred to the pixel electrodes via the voltage switch module controlled by the control switch; and
when the LCD switches from a three-dimensional (3D) displaying mode to a two-dimensional (2D) displaying mode, using the control switch to control the voltage switch module so that the signal line is enabled to transfer the voltage signal to the corresponding pixel electrode region.

10. The image control method of claim 9, further comprising:
when the LCD switches from the 2D displaying mode to the 3D displaying mode, one of the control switches of the IPS pixel unit controls the voltage switch module of a corresponding one of the pixel electrode regions to disable the voltage signal inputted from the signal line into the pixel electrode region so that this pixel electrode region becomes a dark region, and meanwhile, the other control switches control the voltage switch modules of the other pixel electrode regions to enable voltage signals inputted by corresponding signal lines into the pixel electrode regions so that the other pixel electrode regions become bright regions.

11. The image control method of claim 9, wherein the signal lines are connected to the voltage switch modules so that voltage signals on the signal lines are transferred to the pixel electrodes via the voltage switch modules controlled by a same control switch, or the signal lines are connected to the voltage switch modules so that the voltage signals on the signal lines are transferred to the pixel electrodes via the voltage switch modules that are each controlled by a respective control switch.

12. The image control method of claim 10, wherein each of the voltage switch modules is a semiconductor layer of a TFT.

13. The image control method of claim 12, wherein each of the control switches is a gate line of the TFT.

14. The image control method of claim 10, wherein the signal lines are connected to the voltage switch modules so that voltage signals on the signal lines are transferred to the pixel electrodes via the voltage switch modules controlled by a same control switch, or the signal lines are connected to the voltage switch modules so that the voltage signals on the signal lines are transferred to the pixel electrodes via the voltage switch modules that are each controlled by a respective control switch.
